(19) United States
(12) Patent Application Publication
(10) Pub. No.: US 2026/0214567 A1
(43) Pub. Date: Jul. 23, 2026

(54) APPARATUS AND METHOD FOR CONTROLLING CELL ACTIVATION

(71) Applicant: ELECTRONICS AND TELECOMMUNICATIONS RESEARCH INSTITUTE, Daejeon (KR)

(72) Inventors: Sung Kyung KIM, Daejeon (KR); JeeHyeon NA, Daejeon (KR)

(73) Assignee: ELECTRONICS AND TELECOMMUNICATIONS RESEARCH INSTITUTE, Daejeon (KR)

(21) Appl. No.: 19/455,285

(22) Filed: Jan. 21, 2026

(30) Foreign Application Priority Data
Jan. 22, 2025 (KR) 10-2025-0009660

(51) Int. Cl. H04W 52/02

(52) U.S. Cl. CPC H04W 52/0203

(57) ABSTRACT

Provided is an apparatus for controlling cell activation, which includes: a communication module; and a processor functionally connected to the communication module, wherein the processor is configured to: acquire, using the communication module, statistical information related to load devices consuming energy within an entire cell being monitored, the entire cell including a capacity booster cell and a coverage cell of the capacity booster cell; calculate an integrated energy consumption of an entire network by combining power consumptions of the load devices based on the statistical information; and determine whether to switch an activation state of the capacity booster cell based on the integrated energy consumption.

### CROSS-REFERENCE TO RELATED APPLICATION

This application claims priority to and the benefit of Korean Patent Application No. 10-2025-0009660, filed on Jan. 22, 2025, the disclosure of which is incorporated herein by reference in its entirety.

### BACKGROUND

### 1. Field of the Invention

Various embodiments disclosed in this document relate to energy saving technologies for mobile communications.

### 2. Discussion of Related Art

Since mobile communication systems are used by a very large number of people, a significant amount of energy is consumed at both the terminal side and the base station side. To prevent environmental pollution, it is important that not only base stations but also user terminals be designed to conserve energy. In particular, Internet of Things (IoT) devices and low-power sensor terminals have small battery capacity, and thus energy saving may be even more important for such devices. Therefore, in the mobile communication 3^{rd} Generation Partnership Project (3GPP) standard, energy saving (power saving) of a terminal is supported by defining, during a terminal's discontinuous reception (DRX) cycle, an idle period in which signals are not transmitted or received (no power is used) and a time period in which signal transmission and reception are ensured.

Additionally, 5G base stations that require high-speed data transmission apply ultra-high frequency band communication or massive MIMO technology, and therefore may consume more than three times the power of 4G base stations. Therefore, energy saving (ES) technology in 5G networks has recently been actively studied.

In general, as an energy saving approach for base stations, an energy saving function that switches a specific cell (or a base station corresponding to the cell) on/off according to user distribution or traffic load is provided. In a highly dense cell environment, terminal distribution and data demand situations continuously change, and there may be a certain time in which no terminal is located within a cell. In this case, keeping the cell in an activated state may waste a significant amount of energy, and thus countermeasures therefore are required.

FIG. 1 is a diagram illustrating energy saving of a mobile communication system.

Referring to FIG. 1, a mobile communication system according to a 3GPP standard may include a capacity booster cell B1 and coverage cells C1 and C2.

The capacity booster cell B1 is a hot spot cell intended to increase capacity, and the capacity booster cell B1 may be managed by a booster base station 3.

The coverage cells C1 and C2 may be cells that include at least a portion of coverage of the capacity booster cell B1. The coverage cells C1 and C2 may be managed by coverage cell base stations 1 and 2. The coverage cells C1 and C2 may compensate for the coverage of the capacity booster cell B1 that is in an energy saving state (ES mode).

The capacity booster cell B1 is switched to the ES mode when loads of the coverage cells C1 and C2 are less than or equal to respective thresholds. For example, when loads of the capacity booster cell B1 and the coverage cells C1 and C2 remain less than or equal to load thresholds for a designated period of time, the booster base station 3 may attempt to switch the capacity booster cell B1 into the ES mode. Conversely, when the load in the coverage cells C1 and C2 increases, the coverage cell base stations 1 and 2 may request the booster base station 3 to activate the capacity booster cell B1 that is in the ES mode.

However, a duration for which a cell remains in the ES mode may vary depending on the load threshold, and an energy saving ratio may also vary accordingly. Therefore, energy saving performance may differ depending on how the threshold, which is the criterion for cell-off, is set. However, since it is difficult to find an optimal threshold, base stations have conventionally used a fixed threshold or have grouped a plurality of cells and used a relative threshold. In a situation in which a network traffic load is not large or does not suddenly increase, a higher threshold results in a longer duration in which a cell remains in the ES state, thereby reducing energy consumption of the base station.

However, when a base station turns off a cell for energy saving, power consumption of terminals may conversely increase. For example, when the capacity booster cell is turned off, a terminal located closer to the capacity booster cell than to a coverage cell needs to use more power or use power for a longer period of time to transmit and receive data through the coverage cell, which has a relatively poor channel state. As described above, cell on/off control based simply on a comparison between cell load and a threshold may reduce energy of a base station but may increase power consumption of terminals. As a result, service performance of terminals (e.g., IoT devices) having insufficient power supply may be significantly degraded.

To prevent such constraint, it is required to control cell on/off by comprehensively considering the energy consumption of the entire network (or energy saving of base stations and terminals).

### SUMMARY OF THE INVENTION

Various embodiments disclosed in this document may provide an apparatus and method for controlling cell activation that are capable of providing base station cell on/off by comprehensively considering the energy consumption of base stations and terminals.

The technical objectives of the present invention are not limited to the above, and other objectives may become apparent to those of ordinary skill in the art based on the following description.

According to an aspect of the present invention, there is provided an apparatus for controlling cell activation, which includes: a communication module; and a processor functionally connected to the communication module, wherein the processor is configured to: acquire, using the communication module, statistical information related to load devices consuming energy within an entire cell being monitored, the entire cell including a capacity booster cell and a coverage cell of the capacity booster cell; calculate an integrated energy consumption of an entire network by combining power consumptions of the load devices based on the statistical information; and determine whether to switch an activation state of the capacity booster cell based on the integrated energy consumption.

According to an aspect of the present invention, there is provided an apparatus for controlling cell activation, which includes: a communication module for communicating with base stations in an entire cell being monitored, the entire cell including at least one capacity booster cell and a plurality of coverage cells; and a processor functionally connected to the communication module, wherein the processor is configured to: identify whether there is a target terminal located in one capacity booster cell among the at least one capacity booster cell through the base stations in the entire cell; when the target terminal in the one capacity booster cell is identified, predict a change in integrated energy consumption of the entire network according to switching of an activation state of the one capacity booster cell; and switch the activation state of the capacity booster cell when a change in which the integrated energy consumption decreases is predicted.

According to an aspect of the present invention, there is provided a method of controlling cell activation, which includes: acquiring statistical information related to load devices consuming energy within an entire cell being monitored, the entire cell including a capacity booster cell and a coverage cell of the capacity booster cell; calculating an integrated energy consumption by combining power consumptions of the load devices based on the statistical information; and determining whether to switch an activation state of the capacity booster cell based on the integrated energy consumption.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating energy saving of a mobile communication system;

FIG. 2 is a functional block diagram illustrating an apparatus for controlling cell activation according to an embodiment;

FIG. 3 illustrates an operating environment of an apparatus for controlling cell activation according to an embodiment;

FIG. 4 is a block diagram illustrating a configuration of an apparatus for controlling cell activation according to an embodiment;

FIG. 5 is a schematic flowchart illustrating a method of controlling cell activation according to an embodiment; and

FIG. 6 is a detailed flowchart illustrating a method of controlling cell activation according to an embodiment.

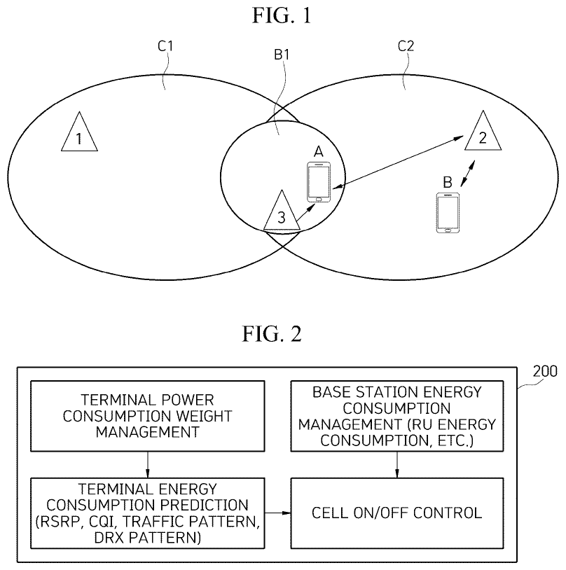

In relation to the description of the drawings, identical or similar reference numerals may be used for identical or similar components.

### DETAILED DESCRIPTION OF EXEMPLARY EMBODIMENTS

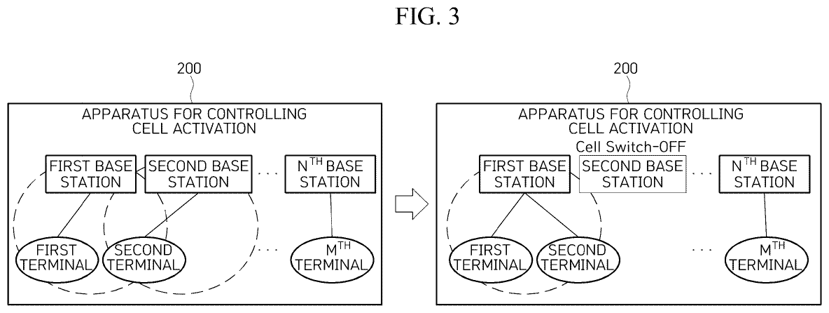

FIG. 2 is a functional block diagram illustrating an apparatus for controlling cell activation according to an embodiment.

Referring to FIG. 2, an apparatus 200 for controlling cell activation may manage energy consumption of load devices including a plurality of base stations (first base station, second base station, . . . , and N^{th} base station) and a plurality of terminals (first terminal, second terminal, . . . , and M^{th} terminal) within an entire cell under management, including a capacity booster cell and coverage cells of the capacity booster cell.

According to an embodiment, the apparatus 200 for controlling cell activation may perform cell on/off control in the entire cell, management of base station energy consumption, prediction of terminal energy consumption, and management of power consumption weights of terminals, in relation to energy consumption management.

According to an embodiment, the apparatus 200 for controlling cell activation may collect statistical information of load devices associated with energy consumption within the entire cell for energy consumption management. For example, the apparatus 200 for controlling cell activation may receive statistical information of base stations within the entire cell from the base stations and receive statistical information of terminals in each cell from a base station connected to the terminals.

The statistical information may include, for example, information related to at least one of: a total data throughput processed in each cell managed by the apparatus 200 for controlling cell activation, a bandwidth usage rate (e.g., physical resource block (PRB) usage) of each cell, the number of active terminals connected to each cell, received signal strength (reference signal received power) of each terminal, a channel quality indicator (e.g., channel quality indicator (CQI)) of each terminal, or power consumption of a base station in each cell. The statistical information may include UEAssistanceInformation messages received from each terminal among the load devices.

The apparatus 200 for controlling cell activation may further acquire cell deployment information (a cell location and an identifier (e.g., base station identification information)) and identify coverage cells associated with a capacity booster cell based on the cell deployment information. For example, the apparatus 200 for controlling cell activation may identify coverage cells capable of compensating for a capacity booster cell area when a capacity booster cell is turned off.

According to an embodiment, the apparatus 200 for controlling cell activation may further collect, as the statistical information, information associated with power consumption weights of respective terminals within the entire cell. For example, the power consumption weights may be set according to specifications and services by a mobile communication network during a process in which each terminal accesses the mobile communication network and notified to each terminal. Each terminal may transmit the power consumption weight to the base station through an additional field in a CapabilityInformation message. The apparatus 200 for controlling cell activation may collect the information associated with terminal power consumption weights through the base station. As another example, the mobile communication network may share information associated with power consumption weights of respective terminals with the base station, and the apparatus 200 for controlling cell activation may collect information associated with power consumption weights of the respective terminals through the base station. The power consumption weight may be set to be relatively higher, for example, for terminals with higher specifications, higher service importance, or smaller battery capacity.

The apparatus 200 for controlling cell activation may calculate (or predict) the power consumptions of terminals in each cell based on the collected statistical information. For example, when there are UEAssistanceInformation messages received from respective terminals within the entire cell, the apparatus 200 for controlling cell activation may calculate terminal power consumption of a corresponding terminal based on the UEAssistanceInformation message. As another example, the apparatus 200 for controlling cell activation may calculate (or predict, or estimate) power consumptions of terminals within the entire cell based on at least one of: channel-state-related information, traffic-pattern-related information, received-data-format-related information, or discontinuous reception (DRX) cycle information of each terminal.

The apparatus 200 for controlling cell activation may calculate power consumptions of terminals by further applying (e.g., multiplying) the power consumption weight. For example, the apparatus 200 for controlling cell activation may calculate power consumption of each terminal as a product of a power consumption weight of the terminal and a calculated power consumption.

The apparatus 200 for controlling cell activation may acquire information associated with energy consumption of each base station from the base station. In this regard, each base station may calculate base station power consumption based on the number of active terminals connected to a cell managed by the base station, received signal strength (reference signal received power) of the active terminals, and channel quality indicators (e.g., CQI) of the active terminals, and transmit the predicted base station power consumption to the apparatus 200 for controlling cell activation.

According to an embodiment, the apparatus 200 for controlling cell activation may calculate an integrated power consumption P(t) by combining (summing) power consumptions consumed by load devices including respective terminals and respective base stations within the entire cell under management as shown in Equation 1 below.

[Equation 1]

$$P ( t ) = {\sum }_{∀ i} {P}_{bs}^{i} ( t ) + {\sum }_{∀ i} {ω}_{j} {P}_{ms}^{j} ( t )$$

In Equation 1 above,

$${P}_{bs}^{i} ( t )$$

represents power consumption of an ith base station (or cell) at time t,

$${P}_{ms}^{j} ( t )$$

represents power consumption of a jth terminal, and ωj represents a power consumption weight. In Equation 1, i and j may be constants less than or equal to the number of base stations and the number of terminals within the entire cell, respectively.

The apparatus 200 for controlling cell activation may calculate an integrated energy consumption EC(t) of the entire network by summing the power consumptions of the terminals and the base stations within the entire cell during a time window W (a designated period) as shown in Equation 2 below.

$$EC ( t ) = {\int }_{t - W}^{t} P ( t ) dt = {\sum }_{∀ i} {EC}_{bs}^{i} ( t ) + {\sum }_{∀ j} {ω}_{j} {EC}_{ms}^{j} ( t ) \qquad [ Equation 2 ]$$

Hereinafter, cell activation control performed by the apparatus 200 for controlling cell activation will be described with reference to FIG. 3. FIG. 3 illustrates an operating environment of an apparatus for controlling cell activation according to an embodiment.

Referring to FIG. 3, the apparatus 200 for controlling cell activation according to an embodiment may receive statistical information from a plurality of base stations (a first base station, . . . , and an N^{th} base station) and a plurality of terminals (a first terminal, . . . , and an M^{th} terminal) within an entire cell under management and control activation of the cell based on the received statistical information. In FIG. 3, the apparatus 200 for controlling cell activation is illustrated as an apparatus separate from the base stations. However, the present disclosure is not limited thereto. For example, the apparatus 200 for controlling cell activation may be included in at least one apparatus among a self-organizing network (SON), an RAN intelligent controller (RIC), or a base station.

According to an embodiment, the apparatus 200 for controlling cell activation may monitor whether a target terminal is located within a capacity booster cell. For example, the apparatus 200 for controlling cell activation may monitor whether a target terminal is located within a capacity booster cell by receiving information associated with a target terminal from a base station of a capacity booster cell or a base station of a coverage cell covering the capacity booster cell.

When the apparatus 200 for controlling cell activation identifies a target terminal in a capacity booster cell, the apparatus 200 for controlling cell activation may predict a change in integrated energy consumption according to switching of an activation state of the capacity booster cell. When the predicted integrated energy consumption is less than or equal to the calculated integrated energy consumption, the apparatus 200 for controlling cell activation may switch the activation state of the capacity booster cell. For example, when the apparatus 200 for controlling cell activation identifies a target terminal located within a capacity booster cell that is in an on state, the apparatus 200 for controlling cell activation may predict the integrated energy consumption when the capacity booster cell is switched to an off state based on the collected statistical information. The apparatus 200 for controlling cell activation may compare a predicted value of integrated energy consumption according to switching of a cell state with an integrated energy consumption of a current cell state, and when the predicted value is smaller, control the base station of the capacity booster cell to switch the capacity booster cell to an off state. Similarly, even when the capacity booster cell is in an off state, the apparatus 200 for controlling cell activation may control cell activation through similar control operations. In this case, the apparatus 200 for controlling cell activation may switch the activation state of the capacity booster cell by requesting switching of an activation state to the base station of the capacity booster cell. On the other hand, when the integrated energy consumption of the current cell state is smaller than the integrated energy consumption according to switching of a cell state, the apparatus 200 for controlling cell activation may maintain the cell activation state of the capacity booster cell even when the location of the terminal within the capacity booster cell changes.

As described above, the apparatus 200 for controlling cell activation according to an embodiment may control cell on/off by comprehensively considering not only the power consumption of the base station but also the power consumption of terminals, thereby improving the issue in which energy consumption of the entire network increases due to an increase in terminal power consumption caused by cell on/off performed for energy saving at base stations.

Additionally, the apparatus 200 for controlling cell activation according to an embodiment may improve the energy saving rate of battery-powered terminals and may differentially support cell environments for each terminal using power consumption weights based on terminal specifications or contributions to mobile communication services (e.g., subscribed services and service importance), thereby increasing user satisfaction for various services.

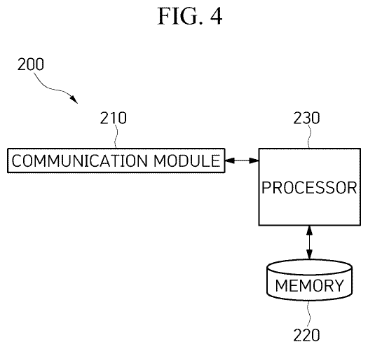

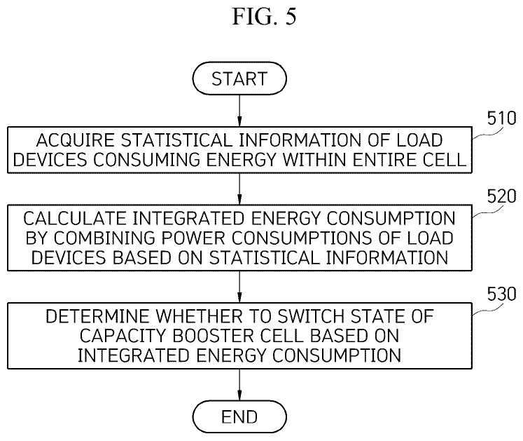

FIG. 4 is a block diagram illustrating a configuration of an apparatus for controlling cell activation according to an embodiment.

Referring to FIG. 4, the apparatus 200 for controlling cell activation according to an embodiment may include a communication module 210, memory 220, and a processor 230. In an embodiment, in the apparatus 200 for controlling cell activation, some components may be omitted or additional components may be added. In addition, some of the components of the apparatus 200 for controlling cell activation may be combined to form a single entity but may perform the same functions as the components before the combination.

The communication module 210 may support the establishment of a communication channel or a wireless communication channel between the apparatus 200 for controlling cell activation and another apparatus (e.g., a base station and a terminal), and the performance of communication through the established communication channel. The communication channel may include, for example, at least one communication channel among a local area network (LAN), fiber to the home (FTTH), a digital subscriber line (xDSL), wireless broadband (WiBro), a wireless LAN, Wi-Fi, Bluetooth, ZigBee, Wi-Fi Direct (WFD), ultra-wideband (UWB), infrared communication (Infrared Data Association (IrDA)), Bluetooth Low Energy (BLE), near field communication (NFC), 3G, 4G, 5G, or 6G.

The memory 220 may include various forms of volatile memories or nonvolatile memories. For example, the memory 220 may include a read only memory (ROM) and a random access memory (RAM). In an embodiment, the memory 220 may be located inside or outside the processor 230, and the memory 220 may be connected to the processor 230 through various known means. The memory 220 may store various types of data used by at least one component (e.g., the processor 230) of the apparatus 200 for controlling cell activation. The data may include, for example, input data or output data for software and instruction related thereto. For example, the memory 220 may store at least one instruction and data for energy consumption calculation and prediction based on statistical information, terminal power consumption weight management, base station power consumption management, or base station cell activation control.

The processor 230 may control at least one other component (e.g., a hardware or software component) of the apparatus 200 for controlling cell activation and may perform various data processing processes or calculations. The processor 230 may include, for example, at least one of a central processing unit (CPU), a graphics processing unit (GPU), a microprocessor, an application processor, an application specific integrated circuit (ASIC), and a field programmable gate array (FPGA), and may have a plurality of cores. According to an embodiment, the processor 230 may manage energy consumption of load devices within the entire cell under management. The apparatus 200 for controlling cell activation may perform on/off control of cells within the entire cell, base station energy consumption management, terminal energy consumption prediction, and terminal power consumption weight management in relation to energy consumption management.

According to an embodiment, the processor 230 may collect statistical information of load devices within the entire cell through the communication module 210. For example, the processor 230 may receive statistical information of base stations within the entire cell from the base stations and receive statistical information of terminals in each cell from a base station connected to the terminals. The statistical information may include, for example, information related to at least one of: a total data throughput processed in each cell under management, a bandwidth usage rate (e.g., PRB usage) of each cell, the number of active terminals connected to each cell, received signal strength (reference signal received power) of each terminal, a channel quality indicator (e.g., CQI) of each terminal, or power consumption of a base station in each cell. The statistical information may include UEAssistanceInformation messages received from each terminal among the load devices.

The processor 230 may further collect information associated with power consumption weights of respective terminals within the entire cell. For example, the power consumption weights may be set according to specifications and services by a mobile communication network during a process in which each terminal accesses the mobile communication network and notified to each terminal. Each terminal may transmit the notified power consumption weight to the base station through an additional field in a CapabilityInformation message. The processor 230 may collect the information associated with terminal power consumption weights through the base station. The power consumption weight may be set to be relatively higher, for example, for terminals with higher specifications, higher service importance, or smaller battery capacity.

In an embodiment, the power consumption weight may be set to reduce power consumption of a designated terminal. For example, the processor 230 or mobile communication network (e.g., a SON, an RIC, or a base station) may relatively set a higher power consumption weight for a designated terminal. The designated terminal may include a terminal using a low-capacity battery that needs to maintain operation for a long period of time from a service implementation perspective or a terminal of a user who has paid high service fees.

The processor 230 may further acquire cell deployment information (a cell location and an identifier) through the communication module 210 and identify coverage cells associated with a capacity booster cell based on the cell deployment information. For example, the processor 230 may identify coverage cells capable of compensating for a capacity booster cell area when a capacity booster cell is turned off.

The processor 230 may predict power consumptions of terminals in each cell based on the collected statistical information. For example, when there are UEAssistanceInformation messages received from respective terminals within the entire cell, the processor 230 may calculate energy consumption of a corresponding terminal based on the terminal power consumption information included in the UEAssistanceInformation message. As another example, the apparatus 200 for controlling cell activation may predict (or calculate) power consumption of terminals within the entire cell based on at least one of: channel-state-related information, traffic-pattern-related information, received-data-format-related information, or DRX cycle information of each terminal among the load devices. The processor 230 may calculate corrected power consumptions of respective terminals by combining (e.g., multiplying) the calculated power consumption of each terminal with power consumption weight information.

The processor 230 may acquire information associated with energy consumption of each base station from the base station through the communication module 210. In this regard, each base station may calculate energy consumption of the base station based on statistical information related to at least one of: a total data throughput processed in each cell within the entire cell, a bandwidth usage rate of each cell, the number of active terminals connected to each cell, signal strength received by each terminal in each cell, and a channel quality indicator of each terminal. Each base station may transmit information associated with the calculated base station energy consumption to the apparatus 200 for controlling cell activation.

According to an embodiment, the processor 230 may calculate an integrated power consumption P(t) by combining power consumptions consumed by each load device including respective terminals and respective base stations within the entire cell under management as shown in Equation 1 above. The processor 230 may calculate the energy consumption EC(t) of the entire cell by summing (integrating (or accumulating)) all power consumptions during a time window W as shown in Equation 2 above.

According to an embodiment, the processor 230 may monitor whether a target terminal is located within one capacity booster cell among capacity booster cells under management. When the processor 230 identifies a target terminal in a capacity booster cell, the processor 230 may predict a change in integrated energy consumption according to switching of an activation state of the capacity booster cell. When the predicted integrated energy consumption is less than or equal to the calculated integrated energy consumption, the processor 230 may switch the activation state of the capacity booster cell.

For example, when the processor 230 identifies a target terminal located in a capacity booster cell, the processor 230 may check the activation state of the capacity booster cell. When the capacity booster cell in which the target terminal is located is in an on state, the processor 230 may predict the integrated energy consumption of the entire network based on the collected statistical information by assuming a case in which the target terminal is connected to the coverage cell compensating for the capacity booster cell according to turning off the capacity booster cell. The processor 230 may compare a predicted value of integrated energy consumption according to switching of a cell state with an integrated energy consumption of a current cell state, and when the predicted value is smaller, may control the base station of the capacity booster cell to switch the capacity booster cell to an off state. Conversely, when the capacity booster cell in which the target terminal is located is in an off state, the processor 230 may predict the integrated energy consumption of the entire network by assuming a case in which the target terminal is connected to the capacity booster cell according to turning on the capacity booster cell. The processor 230 may compare a predicted value of integrated energy consumption according to switching of a cell state (on↔off) with the integrated energy consumption of the current cell state. When the predicted value of integrated energy consumption according to switching of the cell state is less than the calculated value of integrated energy consumption of the current cell state, the processor 230 may control the base station of the capacity booster cell to switch the state of the capacity booster cell.

In an embodiment, the processor 230 may determine whether to switch the activation state of the capacity booster cell when the processor 230 identifies a target terminal entering the capacity booster cell from outside the capacity booster cell.

As described above, the apparatus 200 for controlling cell activation according to an embodiment may control cell on/off by comprehensively considering not only the power consumption of the base station but also the power consumption of terminals, thereby improving the issue in which energy consumption of the entire network increases due to an increase in terminal power consumption caused by cell on/off performed for energy saving at base stations.

Additionally, the apparatus 200 for controlling cell activation according to an embodiment may improve the energy saving rate of battery-powered terminals and may differentially support cell environments for each terminal using power consumption weights based on terminal specifications or contribution to mobile communication services (e.g., subscribed services and service importance), thereby increasing user satisfaction for various services.

FIG. 5 is a schematic flowchart illustrating a method of controlling cell activation according to an embodiment.

Referring to FIG. 5, in operation 510, the apparatus 200 for controlling cell activation may acquire statistical information of load devices consuming energy within the entire cell being monitored, wherein the entire cell includes a capacity booster cell and a coverage cell of the capacity booster cell. The statistical information may include, for example, information related to at least one of: a total data throughput processed in each cell under management, a bandwidth usage rate (e.g., PRB usage) of each cell, the number of active terminals connected to each cell, received signal strength (reference signal received power) of each terminal, a channel quality indicator (e.g., CQI) of each terminal, or power consumption of a base station in each cell. The statistical information may include UEAssistanceInformation messages received from each terminal among the load devices.

In operation 520, the apparatus 200 for controlling cell activation may calculate the integrated energy consumption by combining power consumptions of the load devices based on the statistical information. For example, the apparatus 200 for controlling cell activation may calculate the integrated energy consumption of the entire network by summing (and integrating) the power consumptions of respective terminals and base stations within the entire cell during a designated period of time.

In operation 530, the apparatus 200 for controlling cell activation may determine whether to switch the activation state of the capacity booster cell based on the integrated energy consumption. For example, when there is a terminal in the capacity booster cell, the apparatus 200 for controlling cell activation may predict a change in integrated energy consumption according to switching of the activation state compared to the integrated energy consumption of the current activation state of the capacity booster cell. When the predicted change indicates a decrease, the apparatus 200 for controlling cell activation may control switching of the activation state of the capacity booster cell.

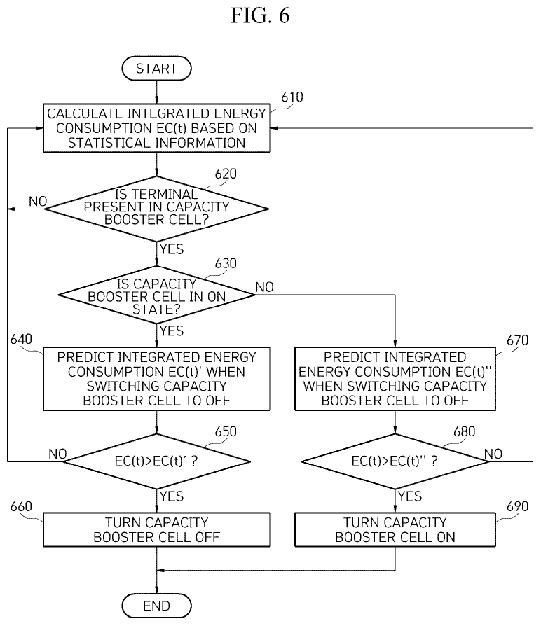

FIG. 6 is a detailed flowchart illustrating a method of controlling cell activation according to an embodiment.

Referring to FIG. 6, in operation 610, the apparatus 200 for controlling cell activation may calculate an integrated energy consumption based on statistical information at a designated time point. The designated time point may include at least one of a periodic time point or a time point at which a change in statistical information is identified.

In operation 620, the apparatus 200 for controlling cell activation may identify whether a terminal is present in a capacity booster cell. For example, the apparatus 200 for controlling cell activation may identify whether a terminal is located in a capacity booster cell based on a message (e.g., including statistical information) received from a base station of the capacity booster cell or a base station of a coverage cell compensating for the capacity booster cell.

When it is identified in operation 620 that a terminal is present in the capacity booster cell, the apparatus 200 for controlling cell activation may, in operation 630, identify whether the capacity booster cell is in an on state or an off state.

When it is identified in operation 630 that the capacity booster cell is in an on state, the apparatus 200 for controlling cell activation may, in operation 640, predict an integrated energy consumption EC(t)′ of the entire network according to switching of the capacity booster cell to an off state.

In operation 650, the apparatus 200 for controlling cell activation may identify whether the integrated energy consumption EC(t)′ according to switching of the capacity booster cell to an off state is less than the integrated energy consumption EC(t) of an on state of the capacity booster cell.

When the integrated energy consumption EC(t)′ according to switching of the capacity booster cell to the off state is less than the integrated energy consumption EC(t) of the on state of the capacity booster cell, the apparatus 200 for controlling cell activation may, in operation 660, perform control such that the capacity booster cell is switched to the off state.

When it is identified in operation 630 that the capacity booster cell is in an off state, the apparatus 200 for controlling cell activation may, in operation 670, predict an integrated energy consumption EC(t)″ of the entire network according to switching of the capacity booster cell to an on state.

In operation 680, the apparatus 200 for controlling cell activation may identify whether the integrated energy consumption EC(t)′ according to switching of the capacity booster cell to an on state is less than the integrated energy consumption EC(t) of the current state (off state) of the capacity booster cell.

When the integrated energy consumption EC(t)″ according to switching of the capacity booster cell to an on state is less than the integrated energy consumption EC(t) of the off state of the capacity booster cell, the apparatus 200 for controlling cell activation may, in operation 690, control the capacity booster cell to be switched to the on state.

As described above, the apparatus 200 for controlling cell activation according to an embodiment may control cell on/off by comprehensively considering not only the power consumption of the base station but also the power consumption of terminals, thereby improving the issue in which energy consumption of the entire network increases due to an increase in terminal power consumption caused by cell on/off performed for energy saving at base stations.

Additionally, the apparatus 200 for controlling cell activation according to an embodiment may improve the energy saving rate of battery-powered terminals and may differentially support cell environments for each terminal according to power consumption weights based on terminal specifications or contributions to mobile communication services (e.g., subscribed services and service importance), thereby increasing user satisfaction for various services.

The various embodiments of the disclosure and terminology used herein are not intended to limit the technical features of the disclosure to the specific embodiments, but rather should be understood to cover all modifications, equivalents, and alternatives falling within the spirit and scope of the invention. Like numbers refer to like elements throughout the description of the drawings. The singular forms preceded by “a” and “an” corresponding to an item are intended to include the plural forms as well unless the context clearly indicates otherwise. In the disclosure, a phrase such as “A or B,” “at least one of A and B,” “at least one of A or B,” “A, B or C,” “at least one of A, B and C,” or “at least one of A, B, or C” may include any one of the items listed together in the corresponding phrase, or any possible combination thereof. Terms such as “first,” “second,” etc., are used to distinguish one element from another and do not modify the elements in other aspects (e.g., importance or sequence). When one (e.g., a first) element is referred to as being “coupled” or “connected” to another (e.g., a second) element with or without the term “functionally” or “communicatively,” it means that the one element is connected to the other element directly (e.g., by wire), wirelessly, or via a third element.

As used herein, the term “module” may include units implemented in hardware, software, or firmware, and may be interchangeably used with terms such as “logic,” “logic block,” “component,” or “circuit.” The module may be an integrally formed component or a minimum unit or part of the integrally formed component that performs one or more functions. For example, according to an embodiment, the module may be implemented in the form of an application-specific integrated circuit (ASIC).

The various embodiments of the present disclosure may be realized by software (e.g., a program) including one or more instructions stored in a storage medium (e.g., the memory 220 (e.g., an internal memory or external memory, a data storage)) that may be read by a machine (e.g., an apparatus for controlling cell activation). For example, a processor (e.g., a processor 230) of the machine (e.g., the apparatus 200 for controlling cell activation) may invoke and execute at least one instruction among the stored one or more instructions from the storage medium. Accordingly, the machine operates to perform at least one function in accordance with the invoked at least one command. The one or more instructions may include code generated by a compiler or code executable by an interpreter. The machine-readable storage medium may be provided in the form of a non-transitory storage medium. Here, when a storage medium is referred to as “non-transitory,” it may be understood that the storage medium is tangible and does not include a signal (for example, electromagnetic waves), but rather that data is semi-permanently or temporarily stored in the storage medium.

According to an embodiment, the methods according to the various embodiments disclosed herein may be provided in a computer program product. The computer program product may be traded between a seller and a buyer as a product. The computer program product may be distributed in the form of a machine-readable storage medium (e.g., a compact disc read only memory (CD-ROM)) or may be distributed directly between two user devices (e.g., smartphones) through an application store (e.g., Play Store™), or online (e.g., downloaded or uploaded). In the case of online distribution, at least a portion of the computer program product may be stored at least semi-permanently or may be temporarily generated in a machine-readable storage medium, such as a memory of a server of a manufacturer, a server of an application store, or a relay server.

Components according to various embodiments of the disclosure may be implemented in the form of software or hardware, such as a digital signal processor (DSP), an FPGA, or an ASIC, and may perform predetermined functions. The term “elements” is not limited to meaning software or hardware. Each of the elements may be stored in a storage medium capable of being addressed and configured to execute one or more processors. For example, the elements may include elements such as software elements, object-oriented software elements, class elements, and task elements, processes, functions, attributes, procedures, subroutines, segments of program code, drivers, firmware, microcode, circuits, data, databases, data structures, tables, arrays, and variables.

According to the various embodiments, each of the above-described elements (e.g., a module or a program) may include a singular entity or a plurality of entities. According to various embodiments, one or more of the above-described elements or operations may be omitted, or one or more other elements or operations may be added. Alternatively, or additionally, a plurality of elements (e.g., modules or programs) may be integrated into one element. In this case, the integrated element may perform one or more functions of each of the plurality of elements in a manner the same as or similar to that performed by the corresponding element of the plurality of components before the integration. According to various embodiments, operations performed by a module, program, or other elements may be executed sequentially, in parallel, repeatedly, or heuristically, or one or more of the operations may be executed in a different order, or omitted, or one or more other operations may be added.

As is apparent from the above, according to the present invention, base station cell on/off can be provided by comprehensively considering energy consumption of base stations and terminals. In addition, various effects that are directly or indirectly identified through this document can be provided.

What is claimed is:

1. An apparatus for controlling cell activation, the apparatus comprising:
a communication module; and
a processor functionally connected to the communication module,
wherein the processor is configured to:
acquire, using the communication module, statistical information related to load devices consuming energy within an entire cell being monitored, the entire cell including a capacity booster cell and a coverage cell of the capacity booster cell;
calculate an integrated energy consumption of an entire network by combining power consumptions of the load devices based on the statistical information; and
determine whether to switch an activation state of the capacity booster cell based on the integrated energy consumption.

2. The apparatus of claim 1, wherein the statistical information includes UEAssistanceInformation messages received from respective terminals among the load devices.

3. The apparatus of claim 1, wherein the statistical information includes information related to at least one of: a total data throughput processed in each cell of the entire cell, a bandwidth usage rate of each cell of the entire cell, a number of active terminals connected to each of the cells, received signal strength of each terminal present in each of the cells, a channel quality indicator (CQI) of each of the terminals, or power consumption of a base station related to each of the cells.

4. The apparatus of claim 1, wherein the processor predicts power consumptions of terminals within the entire cell based on at least one of: channel-state-related information, traffic-pattern-related information, received-data-format-related information, or discontinuous reception (DRX) cycle information of each terminal among the load devices.

5. The apparatus of claim 4, wherein the channel-state-related information includes a channel quality indicator (CQI) and reference signal received power (RSRP).

6. The apparatus of claim 1, wherein, when a UEAssistanceInformation message received from a terminal among the load devices is present, the processor identifies an energy consumption of the terminal from which the UEAssistanceInformation message is received based on power consumption information of the terminal included in the UEAssistanceInformation message.

7. The apparatus of claim 1, wherein the processor identifies power consumption weights according to specifications and services of respective terminals present in the entire cell and calculates power consumptions of the respective terminals by applying the identified power consumption weights to the respective terminals.

8. The apparatus of claim 7, wherein the processor assigns a higher power consumption weight to a terminal having a relatively higher specification or associated with a more important service among the terminals present in entire cell.

9. The apparatus of claim 1, wherein the processor, when a target terminal located in the capacity booster cell is identified, predicts an integrated energy consumption changed according to switching of the activation state of the capacity booster cell, and switches the activation state of the capacity booster cell when the predicted integrated energy consumption is less than the calculated integrated energy consumption.

10. The apparatus of claim 9, wherein the processor, when the target terminal located in the capacity booster cell is identified, calculates the integrated energy consumption by combining power consumption of the target terminal and power consumptions of base stations of the capacity booster cell and the coverage cell, and predicts the integrated energy consumption according to switching of the activation state of the capacity booster cell.

11. The apparatus of claim 1, which is included in at least one apparatus among a self-organizing network (SON), a radio intelligent controller (RIC), or a base station.

12. An apparatus for controlling cell activation, the apparatus comprising:
a communication module for communicating with base stations in an entire cell being monitored, the entire cell including at least one capacity booster cell and a plurality of coverage cells; and
a processor functionally connected to the communication module,
wherein the processor is configured to:
identify whether there is a target terminal located in one capacity booster cell among the at least one capacity booster cell through the base stations in the entire cell;
when the target terminal in the one capacity booster cell is identified, predict a change in integrated energy consumption of the entire network according to switching of an activation state of the one capacity booster cell; and
switch the activation state of the capacity booster cell when the predicted change in integrated energy consumption indicates a decrease.

13. The apparatus of claim 12, wherein the processor, when the one capacity booster cell is in an on state, predicts the integrated energy consumption when the one capacity booster cell, to which the target terminal is connected, is turned off and the target terminal is connected to a coverage cell compensating for the one capacity booster cell.

14. The apparatus of claim 12, wherein the processor, when the one capacity booster cell is in an off state, predicts the integrated energy consumption when the one capacity booster cell is turned on and the target terminal is connected to the one capacity booster cell instead of one coverage cell compensating for the one capacity booster cell.

15. The apparatus of claim 12, wherein the processor calculates the integrated energy consumption of the entire network by summing power consumptions of terminals and base stations present in the entire cell during a designated period.

16. The apparatus of claim 15, wherein the processor calculates the power consumptions of the terminals by applying power consumption weights to the terminals set according to specifications or services of the terminals.

17. The apparatus of claim 14, wherein the processor predicts power consumption of terminals within the entire cell based on information related to at least one of: channel-state-related information, traffic-pattern-related information, received-data-format-related information, or discontinuous reception (DRX) cycle information of each terminal among the load devices.

18. The apparatus of claim 14, wherein, when an UEAssistanceInformation message received from each terminal among the load devices is present, the processor calculates an energy consumption of each of the terminals from which the UEAssistanceInformation message is received based on power consumption information of the terminal included in the UEAssistanceInformation message.

19. The apparatus of claim 14, wherein the power consumption of each of the base stations is calculated by each of the base stations based on statistical information related to at least one of: a total data throughput processed in each cell of the entire cell, a bandwidth usage rate of each cell of the entire cell, a number of active terminals connected to each of the cells of the entire cell, received signal strength of each terminal present in each of the cells, or a channel quality indicator (CQI) of each of the terminals, and the calculated power consumption of each of the base stations is received through the communication module.

20. A method of controlling cell activation, the method comprising:
acquiring statistical information related to load devices consuming energy within an entire cell being monitored, the entire cell including a capacity booster cell and a coverage cell of the capacity booster cell;
calculating an integrated energy consumption by combining power consumptions of the load devices based on the statistical information; and
determining whether to switch an activation state of the capacity booster cell based on the integrated energy consumption.
